(19) United States
(12) Patent Application Publication
(10) Pub. No.: US 2026/0286208 A1
(43) Pub. Date: Sep. 24, 2026

(54) FORMULATION FOR ABANDONING OIL WELLS AND PROCESS FOR PRODUCING SAID FORMULATION

(71) Applicants: PETRÓLEO BRASILEIRO S.A. - PETROBRAS, RIO DE JANEIRO (BR); Universidade Federal de Campina Grande - UFCG, Campina Grande (BR)

(72) Inventors: Elessandre Alves De SOUZA, Rio de Janeiro (BR); Tiago Almeida De OLIVEIRA, Campina Grande (BR); Mirele Costa Da Silva FARIAS, Campina Grande, Paraíba (BR); Renalle Cristina Alves De Medeiros NASCIMENTO, Jaboatão dos Guararapes (BR); Flavia Camanzi CRUZ, Macaé, Rio de Janeiro (BR); Waleska Rodrigues Pontes Da COSTA, Campina Grande, Paraíba (BR); Luciana Viana AMORIM, Campina Grande (BR); Luis Carlos Marques PIRES, Rio de Janeiro (BR); Anna Carolina Amorim COSTA, Campina Grande (BR); Mário César De Siqueira LIMA, Campina Grande (BR); Victoria Bezerra ROMUALDO, Campina Grande (BR); Marcelo Victor Tomaz De MATOS, Rio de Janeiro (BR); Michelli Karinne Barros Da SILVA, Campina Grande (BR); Ruth Luna Do Nascimento GONÇALVES, Campina Grande (BR); Elis Regina Da Silva De PAIVA, Rio de Janeiro (BR); Laura Rafaela Cavalcanti De OLIVEIRA, Campina Grande (BR); Karine Castro NÓBREGA, Campina Grande (BR)

(73) Assignees: PETRÓLEO BRASILEIRO S.A. - PETROBRAS, RIO DE JANEIRO (BR); Universidade Federal de Campina Grande - UFCG, Campina Grande (BR)

(21) Appl. No.: 19/570,728

(22) Filed: Mar. 18, 2026

(30) Foreign Application Priority Data
Mar. 21, 2025 (BR) 1020250055503

(51) Int. Cl. C09K 8/42; C09K 8/467

(52) U.S. Cl. CPC C09K 8/426; C09K 8/467

(57) ABSTRACT

Formulation applied to the abandonment of oil wells, and its production process, said process comprising steps specifically developed for the effective obtention of the product. The formulation can be used in environmentally sensitive areas near oil production wells, exhibits a long service life and improved thermal resistance. Consequently, there are eliminated concerns related to the particle deposition and the consequent entrapment of mechanical elements in oil wells subjected to abandonment operations. In addition to being reflections of the composition itself, the properties of the aforementioned formulation are also directly related to the way in which the production process is carried out, especially in terms of the order of addition of raw materials and also in relation to process parameters, such as agitation, resting periods, times involved in each of the steps and other correlated aspects.

### RELATED APPLICATION DATA

This application is based on and claims priority to Brazilian Application No. BR 10 2025 005550 3, filed on Mar. 21, 2025, the entire contents of which are incorporated herein by reference.

### FIELD OF THE INVENTION

The present invention pertains to the fields of the petrochemical industry, chemical engineering, oil and gas engineering, organic chemistry, and physical chemistry.

More specifically, the present invention relates to a formulation applied for abandoning oil wells, and its production process, said process comprising steps specifically developed for the effective obtention of the product.

### DESCRIPTION OF THE STATE OF THE ART

Oil engineering requires robust solutions to ensure the safety and stability of the wells, especially in temporary abandonment operations. For this purpose, the e-BIS (Element from the Barrier Integrated Set) fluids are developed to maintain the structural integrity of the wells throughout the abandonment period. These fluids must meet stringent requirements, being able to prevent any fluid flow between the well and the formation, ensuring complete tightness. This is because, unlike other operations such as drilling and completion, in abandonment it is not possible to monitor, correct or replace the fluid if a loss to the formation occurs.

The main function of the e-BIS fluids is to ensure the adequate well isolation by means of an absolute filtration control. During the abandonment, the well is filled with the fluid and maintained under pressure higher than that of the formation, preventing the hydrocarbon migration and avoiding the mechanical destabilization of the well. However, any filtration rate, even a minimal one, can lead to the progressive loss of hydrostatic pressure, compromising the safety of the abandonment.

Another essential requirement for an e-BIS fluid is its permanence. As there is no possibility of intervention for fluid maintenance throughout the abandonment period, it must maintain its physicochemical properties intact under the environmental conditions of the well. The durability of the fluid is a determining criterion for its viability, requiring a composition resistant to a degradation of any kind, whether thermal, biological or chemical. To ensure this longevity, specific accelerated life testing methodologies are necessary, as they allow the evaluation of the behavior of the e-BIS fluids over time.

Although e-BIS formulations are crucial in oil well abandonment operations, there is a range of problems inherent in the application of such fluids. Those currently available have high levels of suspended solids, which makes their use unfeasible in wells located in environmentally sensitive areas and wells with integrity problems, such as wells containing objects inside (fish), ovalized regions and/or severe flow restrictions. Other critical aspects of these formulations containing suspended solids are their inability to be safely disposed of at sea, including in environmentally sensitive areas, where the presence of solid particles represents an ecological risk to organisms such as corals and rhodoliths. In addition, the presence of this particulate matter increases the risk of deposition and accumulation on mechanical components of the well, compromising its proper functioning and the reliability.

Document U.S. Pat. No. 12,129,423, for example, discloses a water-based drilling fluid with xanthan gum and polyols, aimed at improving the quality of geological data acquisition from open-hole wireline logging. Said fluid can be applied in well control situations and used in full reservoir drilling. However, the xanthan gum has high degradability and could not constitute the composition of an abandonment fluid.

The document titled “The influence of chemical additives in filtration control of inhibited drilling fluids”, published in the Brazilian Journal of Petroleum and Gas, describes the influence of chemical additives (starch, high-viscosity carboxymethylcellulose “HV-CMC”, and calcite) in drilling fluids with potassium citrate. A plurality of experiments were carried out to evaluate the rheological and filtration properties of the fluids. The results showed that starch and HV-CMC affect the rheological properties, while all additives influence the filtration properties.

Document RU2375405, finally, discloses a formulation used in oil and gas well drilling. The formulation is composed of carboxymethylcellulose, salt of tartar, glycol, xanthan polymer, lubrication enhancer, and water. The technology disclosed in this document of prior art aims at creating a highly inhibiting and cold-resistant composition, suitable for drilling reservoirs in unstable sediments, with high retention, lubrication, and inhibition capacity. As with the reference in the previous paragraph, this document addresses to a fluid designed for the specific requirements of well drilling operations.

Considering the disclosure above, the state of the art would clearly benefit from a formulation, specifically for oil well abandonment, that can be used in environmentally sensitive areas, offering sophisticated, efficient, and lasting invasion control. Moreover, the aforementioned formulation constitutes an advantage over the prior art due to its high service life and improved thermal resistance, eliminating concerns related to particle deposition and the consequent entrapment of mechanical elements in oil wells undergoing abandonment operations. Finally, the state of the art would also benefit from a production process for said formulation, in which said process comprises robustly developed steps for its effective obtention.

### BRIEF DESCRIPTION OF THE INVENTION

Initially, it should be emphasized that the following description is based on preferred embodiments of the invention, without being limited by the same.

In a first aspect, the present invention relates to a formulation for abandoning oil wells comprising the following components:
(a) a first cellulosic agent;
(b) a second cellulosic agent;
(c) bentonite clay;
(d) glycerin (1,2, 3-propanetriol); and
(e) water,
wherein (i) the first cellulosic agent is a low viscosity polyanionic cellulose (LV-PAC) or a low viscosity carboxymethylcellulose (LV-CMC), and (ii) the second cellulosic agent is a high viscosity polyanionic cellulose (HV-PAC) or a high viscosity carboxymethylcellulose (HV-CMC).

In a second aspect, the present invention relates to a process for producing a formulation for abandoning oil wells, said process comprising the following steps:
(a) adding bentonite clay to water, and agitation; obtaining a first viscous bed;
(b) adding the antifoaming agent, sodium bicarbonate, the first cellulosic agent and the second cellulosic agent in a sodium chloride solution, and agitation; obtaining a second viscous bed;
(c) keeping the first and second viscous beds at rest; and
(d) mixing the first viscous bed into the second viscous bed, followed by the addition of water, sodium hydroxide, magnesium oxide, glycerin and bactericide, and agitation; and obtaining the formulation for abandoning oil wells.

### BRIEF DESCRIPTION OF THE FIGURES

For a better understanding of the nature and objectives of the present invention, in order to assist in identifying the main characteristics of the composition of the present invention and its technical results and effects, the figures to which reference is made are presented as follows:

FIG. 1—average values of the apparent viscosity of the green e-BIS fluid obtained in each condition of the sampling plan and of the original fluid.

FIG. 2—e-BIS fluid exposed for 4 days at 170° C. after resting at room temperature for 7 days.

FIG. 3—average values of the filtrate volume of the e-BIS fluid obtained under the tested conditions of the sampling plan and of the original fluid.

### DETAILED DESCRIPTION OF THE INVENTION

In a first aspect, the present invention relates to a FORMULATION FOR ABANDONING OIL WELLS comprising the following components:
(a) a first cellulosic agent;
(b) a second cellulosic agent;
(c) bentonite clay;
(d) glycerin (1,2, 3-propanetriol); and
(e) water,
wherein (i) the first cellulosic agent is a low viscosity polyanionic cellulose (LV-PAC) or a low viscosity carboxymethylcellulose (LV-CMC), and (ii) the second cellulosic agent is a high viscosity polyanionic cellulose (HV-PAC) or a high viscosity carboxymethylcellulose (HV-CMC).

For the purposes of better understanding of the present invention, the formulation for abandoning oil wells will hereafter be referred to simply as the “formulation”.

In a non-restrictive embodiment of the present invention, the components are present in the formulation at the following concentrations:
(a) 1 to 10 lbm/bbl (2.853 to 28.53 kg/m³) of the first cellulosic agent, preferably 4 lbm/bbl (11.412 kg/m³);
(b) 0.1 to 1 lbm/bbl (0.285 to 2.853 kg/m³) of the second cellulosic agent, preferably 0.25 lbm/bbl (0.713 kg/m³);
(c) 5 to 30 lbm/bbl (14.265 to 85.59 kg/m³) of bentonite clay, preferably 10 lbm/bbl (28.53 kg/m³); and
(d) 20 to 300 lbm/bbl (57.06 to 855.903 kg/m³) of glycerin, preferably 200 lbm/bbl (570.602 kg/m³), wherein water is the diluent of said formulation.

In a non-restrictive embodiment of the present invention, the formulation further comprises the following components:
(e) sodium bicarbonate (NaHCO₃);
(f) an antifoaming agent;
(g) sodium hydroxide (NaOH);
(h) magnesium oxide (MgO);
(i) sodium chloride (NaCl); and
(j) a bactericide.

In a non-restrictive embodiment of the present invention, said additional components are present in the formulation at the following concentrations:
(e) 0.1 to 1 lbm/bbl (0.285 to 2.853 kg/m³) of sodium bicarbonate, preferably 0.5 lbm/bbl (1.427 kg/m³);
(f) 0.1 to 1 lbm/bbl (0.285 to 2.853 kg/m³) of antifoaming agent, preferably 0.3 lbm/bbl (0.856 kg/m³);
(g) 0.1 to 1 lbm/bbl (0.285 to 2.853 kg/m³) of sodium hydroxide, preferably 0.2 lbm/bbl (0.571 kg/m³);
(h) 1 to 5 lbm/bbl (2.853 to 14.265 kg/m³) of magnesium oxide, preferably 3 lbm/bbl (8.559 kg/m³);
(i) 4.41 to 126 lbm/bbl (12.582 to 359.479 kg/m³) of sodium chloride, preferably 108 lbm/bbl (308.125 kg/m³); and
(j) 0.1 to 1 lbm/bbl (0.285 to 2.853 kg/m³) of bactericide, preferably 0.3 lbm/bbl (0.856 kg/m³).

In a non-restrictive embodiment of the present invention, the antifoaming agent is selected from the group comprising a nonionic surfactant, silicone compounds, high molecular weight alcohol or compositions prepared with mixtures of these components, preferably the nonionic surfactant, wherein the nonionic surfactant is preferably 2, 2, 4-trimethylpentane 1, 3-diol monoisobutyrate.

In a non-restrictive embodiment of the present invention, the bactericide is selected from the group comprising saturated dialdehydes or triazines, preferably saturated dialdehydes, wherein said saturated dialdehydes are preferably glutaraldehyde.

In a second aspect, the present invention relates to a PROCESS FOR PRODUCING the formulation for abandoning oil wells, said process comprising the following steps:
(a) adding bentonite clay to water, and agitation; obtaining a first viscous bed;
(b) adding the antifoaming agent, sodium bicarbonate, the first cellulosic agent and the second cellulosic agent in a sodium chloride solution, and agitation; obtaining a second viscous bed;
(c) keeping the first and second viscous beds at rest; and
(d) mixing the first viscous bed into the second viscous bed, followed by the addition of glycerin, sodium hydroxide, magnesium oxide and bactericide, and agitation; and obtaining the formulation for abandoning oil wells.

In a non-restrictive embodiment of the present invention, the process steps described herein are performed under the following conditions:
in step (a), the agitation is carried out for a time of 10 to 30 minutes, preferably 20 minutes, at a temperature of 20 to 25° C., preferably 22° C., with the agitation rate being 1000 to 5000 rpm, preferably 3000 rpm;
in step (b), the agitation is carried out for a time of 10 to 30 minutes, preferably 20 minutes, at a temperature of 20 to 25° C., preferably 22° C., with the agitation rate being 1000 to 5000 rpm, preferably 3000 rpm; and
in step (d), the agitation is carried out for a time of 10 to 30 minutes, preferably 20 minutes, at a temperature of 20 to 25° C., preferably 22° C., with the agitation rate being 1000 to 5000 rpm, preferably 3000 rpm.

In a non-restrictive embodiment of the present invention, in step (a), the viscous bed comprises bentonite clay at a concentration of 35 lbm/bbl (99.86 kg/m³), and, in step (b), the sodium chloride solution is an aqueous solution at the concentration as described in the formulation for abandoning oil wells.

In a non-restrictive embodiment of the present invention, in step (c), the first and second viscous beds are kept at rest for a period of 1 to 40 hours, preferably 10 to 30 hours, more preferably 16 hours, wherein said rest is carried out at a temperature of 22° C.

### EXAMPLES

Preferred examples by which the present invention is conceived by the technician skilled on the subject will be described below. However, such examples do not limit the scope of protection of the present invention, and are disclosed herein only for the purpose of better understanding the same.

### Example 1

A preferred and non-restrictive example of the present invention is the formulation production process involving the mixing of the components, as described in Table 1.

TABLE 1
Composition of the formulation for abandoning oil wells.

| Formulation | Concentration | |
|---|---|---|
| Industrial water | Diluent | |
| NaHCO₃ | 0.5 | lbm/bbl |
| Antifoaming Agent | 0.3 | lbm/bbl |
| (non-ionic surfactant 2,2,4- | | |
| trimethylpentane 1,3-diol | | |
| monoisobutyrate) | | |
| Low-viscosity polyanionic | 4.0 | lbm/bbl |
| cellulose (LV PAC) | | |
| High-viscosity polyanionic | 0.25 | lbm/bbl |
| cellulose (HV PAC) | | |
| Sodium bentonite clay | 10 | lbm/bbl |
| Sodium hydroxide (NaOH) | 0.2 | lbm/bbl |
| Magnesium oxide (MgO) | 3.0 | lbm/bbl |
| 1,2,3-propanetriol (glycerin) | 200 | lbm/bbl |
| NaCl | 108 | lbm/bbl |
| Glutaraldehyde | 0.3 | lbm/bbl |

1 lbm/bbl = 2.853 kg/m³

The formulation was prepared in three steps: initially, a bentonite viscous bed in water was prepared at a concentration of 35 lbm/bbl (99.86 kg/m³). The mixture was agitated for 20 minutes at a rate of 3000 rpm at a temperature of 22° C. Then, a polymeric viscous bed was prepared by adding, to an NaCl aqueous solution at the concentration described in the formulation, the antifoaming agent, sodium bicarbonate, and the polymers (LV PAC and HV PAC). The additives were added separately, with a 5-minute agitation interval between each addition. The agitation rate used for the antifoaming agent and sodium bicarbonate was 2000 rpm, for LV PAC, 4500 rpm, and for HV PAC, 5000 rpm. The polymeric viscous bed was prepared at a temperature of 22° C. The viscous beds were left at rest for 16 hours at a temperature of 22° C. After this period, the two beds were mixed and the other additives were added. As with the polymeric viscous bed, the other additives were added with a 5-minute agitation interval between each one, at a rate of 5000 rpm and a temperature of 22° C.

The fluids were prepared in a Silverson mixer, model L5MA, in 2.45 L batches (7 aliquots of 350 mL).

### Example 2

### Accelerated Life Tests

During the temporary abandonment operation, the fluid column used as a safety barrier is exposed to the well temperature conditions, and it is essential that it maintains its properties adequately over the time designed for the fluid to act as a barrier. In this way, it becomes necessary to evaluate the fluid performance when exposed to different temperatures for varying periods. For this purpose, the accelerated life testing methodology was used to estimate the useful life of the formulation for abandoning oil wells (hereinafter referred to as green e-BIS fluid). The sampling plan, containing the time and temperature conditions used in the accelerated life tests, and the number of samples tested under each condition, is presented in Table 2. In addition, fourteen fluids without prior temperature exposure (original fluid) were also tested, in order to know their properties and serve as a reference for determining failure.

For temperature exposure, 350 mL aliquots of the fluid were confined in steel cells with an internal Teflon lining and pressurized to 100 psi (689, 5 kPa) with nitrogen gas. These cells, in turn, were placed in ovens and subjected to the temperatures and inspection times specified in the sampling plan.

TABLE 2
Sampling plan for accelerated life tests.

| | | |
|---|---|---|
| Temperature | Inspection times | Number of samples |

| | | | |
|---|---|---|---|
| 110° C. | 20 | days | 7 |
| | 25 | days | 7 |
| | 30 | days | 7 |
| | 40 | days | 6 |
| 140° C. | 6 | days | 14 |
| | 7 | days | 13 |
| | 8 | days | 12 |
| | 9 | days | 7 |
| | 10 | days | 6 |
| | 11 | days | 7 |
| | 12 | days | 6 |
| | 13 | days | 7 |
| | 14 | days | 6 |
| | 20 | days | 13 |
| | 25 | days | 11 |
| | 30 | days | 14 |
| 150° C. | 5 | days | 16 |
| | 6 | days | 15 |
| | 7 | days | 14 |
| | 8 | days | 14 |
| | 9 | days | 14 |
| | 10 | days | 14 |
| | 11 | days | 15 |
| | 12 | days | 14 |
| 160° C. | 1 | day | 14 |
| | 2 | days | 14 |
| | 3 | days | 13 |
| | 4 | days | 13 |
| | 5 | days | 14 |
| | 6 | days | 14 |
| 170° C. | 1 | day | 14 |
| | 2 | days | 15 |
| | 3 | days | 14 |
| | 4 | days | 15 |

### Characterization of the Fluids

The fluids were characterized by means of pH, density (φ, rheology and HPHT filtrate volume (VF) tests. The pH of the fluids was measured using a benchtop pH meter and the density using a FANN model 140 mud balance. The rheology of the fluids was determined using a Thermo Scientific Haake Mars 60 rheometer. The apparent viscosity (n) was measured in the rheometer at a shear rate of 170.3 s⁻¹. The filtrate volume was determined using a FANN model 387 HPHT filter press for a period of 30 minutes, at a temperature of 150° F. (65.56° C.) and a pressure of 300 psi (2.068 MPa).

### Results and Discussion

Table 3 presents the results of the characterization of the fourteen samples of the original fluid.

TABLE 3
Properties of the green e-BIS fluid (original fluid).

| | | r | VF | h |
|---|---|---|---|---|
| Sample | pH | (lbm/gal) | (mL) | (cP) |
| F1 | 10.05 | 9.8 | 5.6 | 168.32 |
| F2 | 10.05 | 9.8 | 6.2 | 160.34 |
| F3 | 10.09 | 9.8 | 6.4 | 161.06 |
| F4 | 10.14 | 9.8 | 6.0 | 160.16 |
| F5 | 10.27 | 9.9 | 6.4 | 152.73 |
| F6 | 10.29 | 9.9 | 6.0 | 153.75 |
| F7 | 10.31 | 9.9 | 6.8 | 154.95 |
| F8 | 10.17 | 9.8 | 6.6 | 154.01 |
| F9 | 10.16 | 9.7 | 6.4 | 155.62 |
| F10 | 10.20 | 9.8 | 6.6 | 155.79 |
| F11 | 10.18 | 9.8 | 6.0 | 153.68 |
| F12 | 10.40 | 9.9 | 6.0 | 151.26 |
| F13 | 10.40 | 9.9 | 6.4 | 147.80 |
| F14 | 10.42 | 9.8 | 6.4 | 149.31 |
| Average | 10.22 ± | 9.8 ± | 6.3 ± | 155.63 ± |
| | 0.13 | 0.06 | 0.32 | 5.35 |

1 lbm/gal = 119.8 kg/m³

The parameters evaluated for determining the failure of the green e-BIS fluid were the reduction of apparent viscosity (η) to values lower than that observed with the original fluid, and increases in filtrate volume (VF) to values greater than or equal to 10.8 mL.

Tables 4, 5, 6, 7, and 8 present the fluid properties obtained after prior exposure to the temperatures established in the sampling plan.

TABLE 4
Properties of the green e-BIS fluid obtained
after accelerated life tests at 110° C.

| | | | r | VF | h |
|---|---|---|---|---|---|
| Time | Sample | pH | (lbm/gal) | (mL) | (cP) |
| 20 | F1 | 10.51 | 9.9 | 9.0 | 205.67 |
| days | F2 | 10.41 | 9.8 | 8.6 | 188.31 |
| | F3 | 10.47 | 9.9 | 8.8 | 197.55 |
| | F4 | 10.43 | 9.9 | 8.8 | 196.56 |
| | F5 | 10.48 | 9.7 | 9.2 | 184.48 |
| | F6 | 10.49 | 9.7 | 9.0 | 191.42 |
| | F7 | 10.52 | 9.8 | 9.0 | 195.68 |
| | Average | 10.47 ± | 9.8 ± | 8.9 ± | 194.24 ± |
| | | 0.04 | 0.09 | 0.20 | 6.92 |
| 25 | F1 | 10.41 | 9.9 | 9.0 | 183.29 |
| days | F2 | 10.44 | 9.9 | 9.0 | 190.86 |
| | F3 | 10.43 | 9.8 | 9.0 | 189.74 |
| | F4 | 10.46 | 9.9 | 8.0 | 192.19 |
| | F5 | 10.38 | 9.9 | 8.8 | 195.88 |
| | F6 | 10.47 | 9.8 | 9.4 | 199.22 |
| | F7 | 10.53 | 9.7 | 9.4 | 198.21 |
| | Average | 10.45 ± | 9.8 ± | 8.9 ± | 192.77 ± |
| | | 0.05 | 0.08 | 0.47 | 5.53 |
| 30 | F1 | 10.62 | 10 | 8.2 | 259.86 |
| days | F2 | 10.47 | 9.9 | 9.0 | 178.08 |
| | F3 | 10.51 | 9.9 | 9.0 | 180.07 |
| | F4 | 10.57 | 9.8 | 9.2 | 193.46 |
| | F5 | 10.46 | 9.7 | 9.6 | 198.53 |
| | F6 | 10.60 | 9.8 | 7.6 | 213.95 |
| | F7 | 10.51 | 9.7 | 9.0 | 191.76 |
| | Average | 10.53 ± | 9.83 ± | 8.8 ± | 202.25 ± |
| | | 0.06 | 0.11 | 0.67 | 28.09 |
| 40 | F1 | 10.27 | 9.9 | 9.6 | 183.34 |
| days | F2 | 10.24 | 9.8 | 9.2 | 183.48 |
| | F3 | 10.32 | 9.8 | 9.4 | 193.38 |
| | F4 | 10.23 | 9.7 | 9.8 | 195.11 |
| | F5 | 10.36 | 9.9 | 9.4 | 272.91 |
| | F6 | 10.31 | 9.9 | 10.0 | 184.75 |
| | Average | 10.29 ± | 9.8 ± | 9.6 ± | 202.16 ± |
| | | 0.05 | 0.08 | 0.29 | 35.04 |

1 lbm/gal = 119.8 kg/m³

TABLE 5
Properties of the green e-BIS fluid obtained
after accelerated life tests at 140° C.

| | | | r | VF | h |
|---|---|---|---|---|---|
| Time | Sample | pH | (lbm/gal) | (mL) | (cP) |
| 6 | F1 | 10.01 | 9.8 | 9.0 | 408.21 |
| days | F2 | 9.96 | 9.8 | 9.8 | 382.60 |
| | F3 | 10.04 | 9.8 | 9.8 | 410.66 |
| | F4 | 10.02 | 9.8 | 10.0 | 441.62 |
| | F5 | 10.28 | 9.9 | 9.0 | 415.18 |
| | F6 | 10.40 | 9.7 | 8.8 | 426.64 |
| | F7 | 10.28 | 9.9 | 9.6 | 432.72 |
| | F8 | 9.97 | 9.7 | 9.0 | 468.62 |
| | F9 | 10.00 | 9.7 | 9.6 | 492.33 |
| | F10 | 10.16 | 9.9 | 9.2 | 463.58 |
| | F11 | 10.00 | 9.7 | 9.4 | 505.37 |
| | F12 | 9.98 | 9.7 | 9.6 | 477.44 |
| | F13 | 10.10 | 9.8 | 9.4 | 462.06 |
| | F14 | 10.08 | 9.8 | 9.8 | 484.37 |
| | Average | 10.09 ± | 9.8 ± | 9.4 ± | 447.96 ± |
| | | 0.14 | 0.08 | 0.38 | 36.56 |
| 7 | F1 | 9.93 | 9.8 | 8.6 | 437.11 |
| days | F2 | 9.88 | 9.9 | 9.4 | 427.93 |
| | F3 | 9.86 | 9.9 | 9.0 | 464.11 |
| | F4 | 9.88 | 9.9 | 8.6 | 404.11 |
| | F5 | 9.80 | 9.9 | 9.0 | 418.24 |
| | F6 | 10.02 | 9.9 | 8.4 | 443.99 |
| | F7 | 10.01 | 9.9 | 8.0 | 446.50 |
| | F8 | 9.99 | 9.9 | 9.4 | 481.13 |
| | F9 | 10.05 | 9.8 | 9.6 | 477.81 |
| | F10 | 10.06 | 9.9 | 9.0 | 508.36 |
| | F11 | 10.05 | 9.9 | 9.0 | 508.18 |
| | F12 | 10.09 | 9.7 | 8.6 | 471.40 |
| | F13 | 10.03 | 9.9 | 9.2 | 464.26 |
| | Average | 9.97 ± | 9.9 ± | 8.9 ± | 457.93 ± |
| | | 0.09 | 0.06 | 0.45 | 32.13 |
| 8 | F1 | 9.99 | 9.9 | 10.2 | 409.92 |
| days | F2 | 9.86 | 9.9 | 9.2 | 458.53 |
| | F3 | 10.01 | 9.9 | 8.8 | 573.85 |
| | F4 | 9.94 | 9.9 | 9.8 | 442.83 |
| | F5 | 9.95 | 9.9 | 9.4 | 504.10 |
| | F6 | 9.99 | 9.9 | 9.8 | 461.96 |
| | F7 | 10.01 | 9.9 | 9.8 | 467.24 |
| | F8 | 10.00 | 9.9 | 9.6 | 504.58 |
| | F9 | 10.00 | 9.8 | 9.2 | 472.76 |
| | F10 | 9.98 | 9.8 | 9.8 | 458.81 |
| | F11 | 10.02 | 9.9 | 8.6 | 477.41 |
| | F12 | 10.09 | 9.9 | 9.6 | 504.27 |
| | Average | 9.99 ± | 9.9 ± | 9.5 ± | 478.02 ± |
| | | 0.05 | 0.04 | 0.46 | 40.77 |
| 9 | F1 | 9.91 | 9.9 | 9.8 | 453.33 |
| days | F2 | 9.91 | 9.9 | 10.4 | 434.00 |
| | F3 | 9.92 | 9.8 | 9.0 | 421.51 |
| | F4 | 9.90 | 9.8 | 10.4 | 443.44 |
| | F5 | 10.07 | 9.9 | 9.8 | 465.16 |
| | F6 | 10.05 | 9.8 | 10.4 | 457.88 |
| | F7 | 10.20 | 9.8 | 9.6 | 453.57 |
| | Average | 9.99 ± | 9.8 ± | 9.9 ± | 446.98 ± |
| | | 0.12 | 0.05 | 0.53 | 15.07 |
| 10 | F1 | 10.03 | 9.8 | 10.0 | 415.61 |
| days | F2 | 10.05 | 9.8 | 9.6 | 412.86 |
| | F3 | 10.01 | 9.9 | 9.0 | 443.88 |
| | F4 | 10.12 | 9.9 | 9.4 | 517.32 |
| | F5 | 10.16 | 9.9 | 10.6 | 506.91 |
| | F6 | 10.06 | 9.8 | 9.8 | 470.52 |
| | Average | 10.1 ± | 9.9 ± | 9.7 ± | 461.18 ± |
| | | 0.06 | 0.05 | 0.61 | 44.82 |
| 11 | F1 | 9.87 | 9.80 | 9.6 | 494.54 |
| days | F2 | 9.82 | 9.9 | 6.6 | 505.89 |
| | F3 | 9.80 | 9.8 | 9.6 | 424.84 |
| | F4 | 9.87 | 9.8 | 7.4 | 455.18 |
| | F5 | 9.83 | 9.9 | 9.8 | 423.97 |
| | F6 | 9.95 | 9.9 | 7.8 | 524.42 |
| | F7 | 9.90 | 9.9 | 10.4 | 445.72 |
| | Average | 9.86 ± | 9.9 ± | 8.7 ± | 467.79 ± |
| | | 0.05 | 0.05 | 1.37 | 42.93 |
| 12 | F1 | 9.85 | 9.9 | 9.4 | 536.26 |
| days | F2 | 9.76 | 9.8 | 10.0 | 487.82 |
| | F3 | 9.83 | 9.7 | 10.4 | 459.70 |
| | F4 | 9.86 | 9.9 | 9.8 | 502.28 |
| | F5 | 9.78 | 9.9 | 10.2 | 433.95 |
| | F6 | 9.85 | 9.9 | 10.6 | 422.36 |
| | Average | 9.82 ± | 9.9 ± | 10.1 ± | 473.73 ± |
| | | 0.04 | 0.08 | 0.43 | 43.22 |
| 13 | F1 | 9.74 | 9.8 | 9.2 | 480.01 |
| days | F2 | 9.62 | 9.9 | 9.8 | 446.17 |
| | F3 | 9.62 | 9.8 | 9.6 | 406.12 |
| | F4 | 9.63 | 9.8 | 9.0 | 414.95 |
| | F5 | 9.81 | 9.9 | 9.0 | 438.14 |
| | F6 | 9.86 | 9.9 | 8.0 | 439.58 |
| | F7 | 9.89 | 9.9 | 9.0 | 519.87 |
| | Average | 9.74 ± | 9.9 ± | 9.1 ± | 449.26 ± |
| | | 0.12 | 0.05 | 0.58 | 39.15 |
| 14 | F1 | 9.70 | 9.9 | 9.8 | 420.81 |
| days | F2 | 9.77 | 9.8 | 9.8 | 436.73 |
| | F3 | 9.67 | 9.9 | 9.4 | 433.06 |
| | F4 | 9.79 | 9.9 | 8.2 | 462.81 |
| | F5 | 9.69 | 9.8 | 6.8 | 371.76 |
| | F6 | 9.73 | 9.9 | 9.2 | 411.50 |
| | Average | 9.73 ± | 9.9 ± | 8.9 ± | 422.78 ± |
| | | 0.05 | 0.05 | 1.17 | 30.45 |
| 20 | F1 | 9.38 | 9.7 | 11.4 | 311.59 |
| days | F2 | 9.56 | 9.8 | 10.6 | 426.13 |
| | F3 | 9.27 | 9.8 | 12.2 | 131.09 |
| | F4 | 9.40 | 9.8 | 11.6 | 291.79 |
| | F5 | 9.65 | 9.9 | 9.4 | 498.98 |
| | F6 | 9.52 | 9.6 | 10.4 | 325.82 |
| | F7 | 9.52 | 9.7 | 10.6 | 308.82 |
| | F8 | 9.68 | 9.8 | 10.6 | 477.89 |
| | F9 | 9.52 | 9.7 | 10.8 | 367.47 |
| | F10 | 9.49 | 9.8 | 9.6 | 385.43 |
| | F11 | 9.59 | 9.7 | 10.6 | 394.99 |
| | F12 | 9.60 | 9.8 | 11.8 | 375.12 |
| | F13 | 9.58 | 9.7 | 10.6 | 411.54 |
| | Average | 9.52 ± | 9.8 ± | 10.8 ± | 362.05 ± |
| | | 0.11 | 0.08 | 0.80 | 93.78 |
| 25 | F1 | 9.50 | 9.7 | 11.0 | 372.50 |
| days | F2 | 9.28 | 9.9 | 11.4 | 288.63 |
| | F3 | 9.44 | 9.7 | 11.8 | 206.45 |
| | F4 | 9.32 | 9.6 | 11.4 | 247.12 |
| | F5 | 9.21 | 9.8 | 10.6 | 216.21 |
| | F6 | 9.16 | 9.8 | 8.2 | 261.63 |
| | F7 | 9.20 | 9.9 | 11.4 | 332.46 |
| | F8 | 9.54 | 9.7 | 11.2 | 358.55 |
| | F9 | 9.51 | 9.8 | 12.0 | 365.70 |
| | F10 | 9.41 | 9.8 | 12.2 | 316.09 |
| | F11 | 9.31 | 9.8 | 13.0 | 293.78 |
| | Average | 9.35 ± | 9.8 ± | 11.3 ± | 296.28 ± |
| | | 0.13 | 0.09 | 1.21 | 58.63 |
| 30 | F1 | 9.35 | 9.9 | 9.2 | 393.12 |
| days | F2 | 8.88 | 9.8 | 12.6 | 170.36 |
| | F3 | 9.23 | 9.7 | 11.8 | 282.95 |
| | F4 | 9.14 | 9.8 | 12.6 | 251.45 |
| | F5 | 9.24 | 9.7 | 10.4 | 330.52 |
| | F6 | 9.26 | 9.8 | 13.2 | 363.58 |
| | F7 | 9.04 | 9.6 | 12.0 | 198.62 |
| | F8 | 9.43 | 9.8 | 11.8 | 342.68 |
| | F9 | 9.42 | 9.8 | 12.2 | 323.57 |
| | F10 | 9.37 | 9.8 | 12.2 | 297.91 |
| | F11 | 9.43 | 9.8 | 13.4 | 354.76 |
| | F12 | 9.25 | 9.7 | 13.4 | 305.87 |
| | F13 | 9.52 | 9.8 | 11.8 | 343.49 |
| | F14 | 9.40 | 9.8 | 12.8 | 341.34 |
| | Average | 9.28 ± | 9.8 ± | 12.1 ± | 307.16 ± |
| | | 0.17 | 0.07 | 1.15 | 63.05 |

1 lbm/gal = 119.8 kg/m³

TABLE 6
Properties of the green e-BIS fluid obtained
after accelerated life tests at 150° C.

| | | | r | VF | h |
|---|---|---|---|---|---|
| Time | Sample | pH | (lbm/ gal) | (mL) | (cP) |
| 5 | F1 | 9.71 | 9.9 | 9.6 | 400.88 |
| days | F2 | 9.74 | 9.9 | 9.0 | 435.11 |
| | F3 | 9.69 | 9.9 | 9.6 | 373.05 |
| | F4 | 9.70 | 9.9 | 9.6 | 365.84 |
| | F5 | 9.74 | 9.8 | 10.6 | 323.46 |
| | F6 | 9.76 | 9.8 | 10.4 | 336.62 |
| | F7 | 9.79 | 9.9 | 9.6 | 344.14 |
| | F8 | 9.78 | 9.9 | 9.8 | 412.16 |
| | F9 | 9.85 | 9.9 | 9.8 | 394.19 |
| | F10 | 9.89 | 9.8 | 9.4 | 379.71 |
| | F11 | 9.79 | 9.9 | 8.8 | 348.49 |
| | F12 | 9.92 | 9.9 | 8.2 | 454.01 |
| | F13 | 9.97 | 9.9 | 8.2 | 417.38 |
| | F14 | 9.82 | 9.7 | 9.6 | 403.97 |
| | F15 | 9.80 | 9.6 | 9.8 | 407.64 |
| | F16 | 9.89 | 9.7 | 10.0 | 446.79 |
| | Average | 9.8 ± | 9.8 ± | 9.5 ± | 390.22 ± |
| | | 0.08 | 0.10 | 0.67 | 39.43 |
| 6 | F1 | 9.63 | 9.9 | 9.8 | 339.52 |
| days | F2 | 9.78 | 9.9 | 9.4 | 375.78 |
| | F3 | 9.79 | 9.8 | 9.6 | 406.25 |
| | F4 | 9.71 | 9.9 | 9.8 | 369.45 |
| | F5 | 9.68 | 9.9 | 10.4 | 328.57 |
| | F6 | 9.74 | 9.9 | 10.4 | 396.52 |
| | F7 | 9.75 | 9.8 | 9.8 | 393.91 |
| | F8 | 9.58 | 9.6 | 11.8 | 232.85 |
| | F9 | 9.77 | 9.5 | 10.0 | 352.88 |
| | F10 | 9.80 | 9.7 | 10.2 | 378.13 |
| | F11 | 9.59 | 9.6 | 11.6 | 244.82 |
| | F12 | 9.68 | 9.5 | 11.2 | 314.37 |
| | F13 | 9.76 | 9.5 | 10.4 | 389.81 |
| | F14 | 9.72 | 9.6 | 11.0 | 376.51 |
| | F15 | 9.62 | 9.5 | 11.2 | 285.72 |
| | Average | 9.71 ± | 9.7 ± | 10.4 ± | 345.67 ± |
| | | 0.07 | 0.17 | 0.75 | 54.68 |
| 7 | F1 | 9.68 | 9.8 | 9.8 | 411.35 |
| days | F2 | 9.65 | 9.6 | 11.4 | 306.98 |
| | F3 | 9.60 | 9.8 | 10.2 | 381.34 |
| | F4 | 9.60 | 9.9 | 10.0 | 364.48 |
| | F5 | 9.76 | 9.9 | 8.0 | 460.46 |
| | F6 | 9.88 | 9.9 | 10.8 | 415.15 |
| | F7 | 9.76 | 9.8 | 10.2 | 358.06 |
| | F8 | 9.80 | 9.9 | 9.8 | 377.33 |
| | F9 | 9.57 | 9.8 | 10.8 | 367.56 |
| | F10 | 9.54 | 9.8 | 11.0 | 360.08 |
| | F11 | 9.59 | 9.8 | 11.0 | 417.84 |
| | F12 | 9.57 | 9.9 | 8.8 | 513.39 |
| | F13 | 9.67 | 9.9 | 10.0 | 435.54 |
| | F14 | 9.71 | 9.8 | 10.8 | 389.21 |
| | Average | ±0.09 | ±0.06 | ±0.45 | ±32.13 |
| 8 | F1 | 9.56 | 9.8 | 10.6 | 325.90 |
| days | F2 | 9.57 | 9.8 | 10.4 | 362.42 |
| | F3 | 9.56 | 9.9 | 8.2 | 400.68 |
| | F4 | 9.54 | 9.8 | 10.0 | 346.35 |
| | F5 | 9.68 | 9.8 | 9.6 | 394.99 |
| | F6 | 9.59 | 9.8 | 9.6 | 373.37 |
| | F7 | 9.72 | 9.8 | 10.0 | 391.90 |
| | F8 | 9.58 | 9.8 | 11.0 | 367.15 |
| | F9 | 9.58 | 9.7 | 10.4 | 315.32 |
| | F10 | 9.30 | 9.6 | 13.0 | 186.07 |
| | F11 | 9.48 | 9.9 | 12.0 | 250.61 |
| | F12 | 9.37 | 9.6 | 13.2 | 173.87 |
| | F13 | 9.43 | 9.7 | 11.2 | 212.07 |
| | F14 | 9.76 | 9.8 | 10.0 | 413.55 |
| | Average | 9.55 ± | 9.8 ± | 10.7 ± | 322.45 ± |
| | | 0.13 | 0.09 | 1.36 | 82.90 |
| 9 | F1 | 9.72 | 9.8 | 11.2 | 298.30 |
| days | F2 | 9.85 | 9.7 | 11.0 | 410.85 |
| | F3 | 9.86 | 9.8 | 8.2 | 357.64 |
| | F4 | 9.93 | 9.9 | 9.8 | 399.36 |
| | F5 | 9.84 | 9.9 | 10.8 | 352.87 |
| | F6 | 9.75 | 9.9 | 11.4 | 299.36 |
| | F7 | 9.78 | 9.9 | 11.2 | 355.61 |
| | F8 | 9.90 | 9.8 | 7.4 | 364.13 |
| | F9 | 9.74 | 9.9 | 11.4 | 349.58 |
| | F10 | 9.44 | 9.9 | 12.0 | 266.23 |
| | F11 | 9.46 | 9.5 | 11.4 | 316.61 |
| | F12 | 9.33 | 9.7 | 14.4 | 174.17 |
| | F13 | 9.64 | 9.8 | 10.8 | 343.20 |
| | F14 | 9.65 | 9.7 | 7.8 | 382.46 |
| | Average | 9.71 ± | 9.8 ± | 10.6 ± | 333.60 ± |
| | | 0.18 | 0.12 | 1.83 | 60.80 |
| 10 | F1 | 9.55 | 9.9 | 11.4 | 272.22 |
| days | F2 | 9.41 | 9.9 | 11.0 | 250.29 |
| | F3 | 9.58 | 9.6 | 12.4 | 291.70 |
| | F4 | 9.58 | 9.8 | 11.2 | 274.65 |
| | F5 | 9.80 | 9.8 | 11.8 | 303.16 |
| | F6 | 9.64 | 9.9 | 12.0 | 271.20 |
| | F7 | 9.66 | 9.7 | 10.8 | 319.17 |
| | F8 | 9.58 | 9.9 | 11.4 | 339.69 |
| | F9 | 9.69 | 9.6 | 11.2 | 341.55 |
| | F10 | 9.05 | 9.8 | 34.4 | 108.85 |
| | F11 | 9.55 | 9.6 | 12.4 | 253.95 |
| | F12 | 9.47 | 9.8 | 14.6 | 198.41 |
| | F13 | 9.71 | 9.7 | 11.0 | 296.71 |
| | F14 | 9.81 | 9.8 | 11.4 | 382.66 |
| | Average | 9.58 ± | 9.8 ± | 13.4 ± | 278.87 ± |
| | | 0.19 | 0.11 | 6.13 | 66.82 |
| 11 | F1 | 9.62 | 9.7 | 12.6 | 216.99 |
| days | F2 | 9.63 | 9.8 | 12.4 | 236.21 |
| | F3 | 9.67 | 9.8 | 11.0 | 266.11 |
| | F4 | 9.92 | 9.9 | 10.8 | 345.37 |
| | F5 | 9.61 | 9.9 | 12.4 | 197.11 |
| | F6 | 9.66 | 9.8 | 11.2 | 280.63 |
| | F7 | 9.74 | 9.9 | 11.2 | 237.03 |
| | F8 | 9.27 | 9.7 | 12.4 | 236.62 |
| | F9 | 9.54 | 9.8 | 11.3 | 296.89 |
| | F10 | 9.21 | 9.8 | 12.0 | 230.68 |
| | F11 | 9.07 | 9.7 | 14.2 | 142.06 |
| | F12 | 9.28 | 9.7 | 10.6 | 193.53 |
| | F13 | 9.27 | 9.9 | 14.8 | 164.30 |
| | F14 | 9.36 | 9.9 | 12.0 | 221.85 |
| | F15 | 9.36 | 9.9 | 12.6 | 193.46 |
| | Average | 9.48 ± | 9.8 ± | 12.1 ± | 230.59 ± |
| | | 0.24 | 0.08 | 1.19 | 51.97 |
| 12 | F1 | 9.57 | 9.8 | 13.0 | 224.78 |
| days | F2 | 9.94 | 9.9 | 12.6 | 210.74 |
| | F3 | 9.44 | 9.8 | 13.8 | 192.69 |
| | F4 | 9.88 | 9.9 | 10.2 | 428.24 |
| | F5 | 9.57 | 9.8 | 13.2 | 223.50 |
| | F6 | 9.40 | 9.7 | 15.2 | 175.62 |
| | F7 | 9.77 | 9.9 | 11.2 | 337.69 |
| | F8 | 9.56 | 9.9 | 11.6 | 382.49 |
| | F9 | 9.47 | 9.9 | 11.2 | 298.44 |
| | F10 | 9.30 | 9.8 | 12.8 | 200.45 |
| | F11 | 9.06 | 9.6 | 12.8 | 153.80 |
| | F12 | 8.99 | 9.8 | 17.8 | 138.08 |
| | F13 | 9.05 | 9.7 | 13.6 | 130.65 |
| | F14 | 9.15 | 9.8 | 13.2 | 149.54 |
| | Average | 9.44 ± | 9.8 ± | 13.0 ± | 231.91 ± |
| | | 0.30 | 0.09 | 1.87 | 94.07 |

1 lbm/gal = 119.8 kg/m³

TABLE 7
Properties of the green e-BIS fluid obtained
after accelerated life tests at 160° C.

| | | | r | VF | h |
|---|---|---|---|---|---|
| Time | Sample | pH | (lbm/gal) | (mL) | (cP) |
| 1 | F1 | 9.93 | 9.8 | 7.8 | 285.42 |
| day | F2 | 9.93 | 9.8 | 7.4 | 322.30 |
| | F3 | 9.92 | 9.8 | 8.4 | 313.31 |
| | F4 | 9.91 | 9.8 | 7.6 | 300.51 |
| | F5 | 9.96 | 9.9 | 8.2 | 288.91 |
| | F6 | 9.98 | 9.8 | 8.8 | 279.42 |
| | F7 | 10.02 | 9.9 | 7.6 | 298.32 |
| | F8 | 9.96 | 9.9 | 8.2 | 343.64 |
| | F9 | 9.94 | 9.7 | 7.8 | 321.13 |
| | F10 | 9.98 | 9.7 | 8.0 | 341.29 |
| | F11 | 9.87 | 9.7 | 7.8 | 321.86 |
| | F12 | 10.04 | 9.6 | 8.4 | 324.86 |
| | F13 | 10.03 | 9.7 | 8.4 | 331.83 |
| | F14 | 9.98 | 9.7 | 7.4 | 339.44 |
| | Average | 9.96 ± | 9.8 ± | 8.0 ± | 315.16 ± |
| | | 0.05 | 0.09 | 0.43 | 21.37 |
| 2 | F1 | 9.95 | 9.7 | 9.4 | 356.10 |
| days | F2 | 9.92 | 9.9 | 8.8 | 343.40 |
| | F3 | 9.93 | 9.9 | 9.0 | 312.26 |
| | F4 | 9.94 | 9.8 | 8.0 | 349.35 |
| | F5 | 9.96 | 9.8 | 9.6 | 292.08 |
| | F6 | 9.91 | 9.9 | 10.0 | 303.95 |
| | F7 | 9.94 | 9.8 | 9.8 | 265.00 |
| | F8 | 9.93 | 9.6 | 10.0 | 320.42 |
| | F9 | 9.68 | 9.7 | 12.2 | 145.17 |
| | F10 | 9.80 | 9.7 | 10.8 | 256.26 |
| | F11 | 9.84 | 9.6 | 9.2 | 320.24 |
| | F12 | 9.86 | 9.6 | 10.6 | 232.39 |
| | F13 | 9.86 | 9.9 | 11.0 | 229.53 |
| | F14 | 9.95 | 9.8 | 9.0 | 322.61 |
| | Average | 9.89 ± | 9.8 ± | 9.8 ± | 289.20 ± |
| | | 0.08 | 0.12 | 1.07 | 58.21 |
| 3 | F1 | 9.81 | 9.8 | 10.8 | 280.62 |
| days | F2 | 9.85 | 9.8 | 10.6 | 292.91 |
| | F3 | 9.94 | 9.9 | 10.2 | 321.17 |
| | F4 | 9.88 | 9.9 | 9.6 | 277.98 |
| | F5 | 9.95 | 9.8 | 9.8 | 272.69 |
| | F6 | 10.00 | 9.8 | 9.8 | 302.26 |
| | F7 | 10.02 | 9.8 | 10.0 | 310.94 |
| | F8 | 9.81 | 9.8 | 8.6 | 383.89 |
| | F9 | 9.81 | 9.7 | 9.2 | 389.85 |
| | F10 | 9.60 | 9.8 | 10.8 | 228.90 |
| | F11 | 9.75 | 9.7 | 10.4 | 335.20 |
| | F12 | 9.75 | 9.8 | 10.8 | 318.23 |
| | F13 | 9.80 | 9.9 | 10.0 | 327.40 |
| | Average | 9.84 ± | 9.8 ± | 10.0 ± | 310.93 ± |
| | | 0.12 | 0.06 | 0.66 | 43.94 |
| 4 | F1 | 9.56 | 9.9 | 11.0 | 226.07 |
| days | F2 | 9.55 | 9.9 | 10.8 | 233.52 |
| | F3 | 9.52 | 9.8 | 11.0 | 187.44 |
| | F4 | 9.56 | 9.9 | 11.2 | 230.03 |
| | F5 | 9.56 | 9.8 | 10.4 | 209.63 |
| | F6 | 9.51 | 9.9 | 11.2 | 196.05 |
| | F7 | 9.63 | 9.8 | 10.6 | 271.63 |
| | F8 | 9.65 | 10.0 | 8.6 | 431.32 |
| | F9 | 9.51 | 9.9 | 11.4 | 197.03 |
| | F10 | 9.63 | 9.8 | 12.8 | 192.94 |
| | F11 | 9.54 | 9.9 | 12.4 | 200.25 |
| | F12 | 9.45 | 9.9 | 17.0 | 123.69 |
| | F13 | 9.55 | 9.9 | 15.8 | 151.15 |
| | Average | 9.56 ± | 9.9 ± | 11.9 ± | 219.29 ± |
| | | 0.06 | 0.06 | 2.26 | 73.62 |
| 5 | F1 | 9.41 | 9.8 | 25.0 | 133.52 |
| days | F2 | 9.38 | 9.9 | 26.6 | 129.13 |
| | F3 | 9.73 | 9.8 | 28.0 | 142.73 |
| | F4 | 9.20 | 9.9 | 38.4 | 103.29 |
| | F5 | 9.46 | 9.7 | 21.6 | 129.55 |
| | F6 | 9.38 | 9.9 | 33.6 | 134.90 |
| | F7 | 9.51 | 9.9 | 26.4 | 140.16 |
| | F8 | 9.24 | 9.9 | 37.2 | 83.94 |
| | F9 | 9.37 | 9.9 | 17.2 | 156.42 |
| | F10 | 9.50 | 9.9 | 12.0 | 227.56 |
| | F11 | 9.58 | 9.9 | 11.0 | 279.07 |
| | F12 | 9.31 | 9.8 | 23.8 | 116.44 |
| | F13 | 9.32 | 9.9 | 22.6 | 137.24 |
| | F14 | 9.21 | 9.8 | 28.2 | 78.79 |
| | Average | 9.40 ± | 9.9 ± | 25.1 ± | 142.34 ± |
| | | 0.15 | 0.06 | 8.18 | 52.85 |
| 6 | F1 | 9.36 | 9.7 | 17.6 | 114.84 |
| days | F2 | 9.54 | 9.7 | 12.8 | 179.48 |
| | F3 | 9.76 | 9.7 | 28.4 | 157.39 |
| | F4 | 9.75 | 9.9 | 30.4 | 144.38 |
| | F5 | 9.87 | 9.9 | 14.4 | 196.23 |
| | F6 | 9.80 | 9.9 | 13.2 | 181.09 |
| | F7 | 9.61 | 9.7 | 36.4 | 132.07 |
| | F8 | 9.68 | 9.8 | 32.4 | 144.47 |
| | F9 | 9.28 | 9.9 | 15.2 | 168.23 |
| | F10 | 8.05 | 9.9 | 104.0 | 94.15 |
| | F11 | 9.49 | 9.3 | 11.2 | 267.60 |
| | F12 | 9.21 | 9.8 | 27.2 | 138.17 |
| | F13 | 8.89 | 9.9 | 58.0 | 87.03 |
| | F14 | 9.48 | 9.9 | 13.8 | 254.61 |
| | Average | 9.41 ± | 9.8 ± | 29.6 ± | 161.41 ± |
| | | 0.47 | 0.17 | 25.00 | 52.74 |

1 lbm/gal = 119.8 kg/m³

TABLE 8
Properties of the green e-BIS fluid obtained
after accelerated life tests at 170° C.

| | | | r | VF | h |
|---|---|---|---|---|---|
| Time | Sample | pH | (lbm/ gal) | (mL) | (cP) |
| 1 | F1 | 9.82 | 9.9 | 8.8 | 218.11 |
| day | F2 | 9.84 | 9.9 | 9.0 | 198.16 |
| | F3 | 9.88 | 9.8 | 8.8 | 245.52 |
| | F4 | 9.84 | 9.8 | 9.8 | 218.75 |
| | F5 | 10.06 | 9.8 | 7.6 | 235.88 |
| | F6 | 10.07 | 9.9 | 8.8 | 256.79 |
| | F7 | 10.02 | 9.9 | 9.6 | 180.60 |
| | F8 | 9.79 | 9.8 | 9.0 | 211.25 |
| | F9 | 9.70 | 9.9 | 9.8 | 177.31 |
| | F10 | 9.82 | 9.8 | 8.6 | 207.92 |
| | F11 | 9.87 | 9.6 | 8.6 | 224.21 |
| | F12 | 9.93 | 9.8 | 7.8 | 195.10 |
| | F13 | 9.93 | 9.8 | 9.6 | 578.98 |
| | F14 | 9.93 | 9.9 | 8.6 | 220.87 |
| | Average | 9.89 ± | 9.8 ± | 8.9 ± | 240.67 ± |
| | | 0.11 | 0.08 | 0.67 | 99.95 |
| 2 | F1 | 9.76 | 9.8 | 12.4 | 184.40 |
| days | F2 | 9.80 | 9.8 | 10.6 | 195.84 |
| | F3 | 9.54 | 9.9 | 11.8 | 152.45 |
| | F4 | 9.79 | 9.9 | 10.2 | 248.87 |
| | F5 | 9.68 | 9.6 | 10.8 | 180.70 |
| | F6 | 9.70 | 9.8 | 12.4 | 155.20 |
| | F7 | 9.46 | 9.9 | 22.4 | 108.14 |
| | F8 | 9.54 | 9.6 | 14.0 | 115.52 |
| | F9 | 9.68 | 9.9 | 12.4 | 159.88 |
| | F10 | 9.48 | 9.8 | 18.0 | 129.26 |
| | F11 | 9.51 | 9.8 | 25.6 | 105.58 |
| | F12 | 9.74 | 9.5 | 10.6 | 221.10 |
| | F13 | 10.04 | 9.8 | 10.6 | 256.66 |
| | F14 | 9.53 | 9.8 | 41.4 | 66.37 |
| | F15 | 9.83 | 9.6 | 13.4 | 170.88 |
| | Average | 9.67 ± | 9.8 ± | 15.8 ± | 163.39 ± |
| | | 0.16 | 0.13 | 8.44 | 53.88 |
| 3 | F1 | 9.78 | 9.9 | 36.2 | 104.10 |
| days | F2 | 9.59 | 9.9 | 47.2 | 76.71 |
| | F3 | 9.56 | 9.9 | 54.8 | 70.54 |
| | F4 | 9.60 | 9.9 | 58.0 | 72.45 |
| | F5 | 9.33 | 9.8 | 63.4 | 70.89 |
| | F6 | 9.33 | 9.9 | 63.0 | 58.74 |
| | F7 | 7.95 | 9.6 | 130.2 | 66.69 |
| | F8 | 9.72 | 9.8 | 12.0 | 247.35 |
| | F9 | 9.49 | 9.6 | 13.0 | 160.90 |
| | F10 | 8.72 | 9.7 | 80.0 | 55.04 |
| | F11 | 8.92 | 9.6 | 63.8 | 57.31 |
| | F12 | 9.36 | 9.7 | 50.4 | 68.20 |
| | F13 | 9.40 | 9.8 | 36.0 | 69.20 |
| | F14 | 9.41 | 9.7 | 39.6 | 72.86 |
| | Average | 9.30 ± | 9.8 ± | 53.4 ± | 89.36 ± |
| | | 0.48 | 0.12 | 29.24 | 52.78 |
| | F1 | 8.61 | 9.8 | 84.0 | 62.45 |
| | F2 | 9.24 | 10.0 | 48.8 | 159.54 |
| | F3 | 8.42 | 9.9 | 100.5 | 60.78 |
| | F4 | 8.64 | 9.9 | 91.0 | 81.76 |
| | F5 | 8.72 | 9.8 | 83.6 | 65.81 |
| | F6 | 8.41 | 9.9 | 110.6 | 72.07 |
| | F7 | 8.14 | 9.7 | 126.0 | 78.85 |
| | F8 | 8.84 | 9.9 | 83.0 | 58.50 |
| | F9 | 8.73 | 9.9 | 86.0 | 82.02 |
| | F10 | 8.60 | 9.8 | 100.0 | 70.12 |
| | F11 | 7.99 | 9.5 | 130.4 | 90.96 |
| | F12 | 8.92 | 9.5 | 64.0 | 78.40 |
| | F13 | 8.29 | 9.8 | 122.0 | 78.18 |
| | F14 | 8.08 | 9.8 | 130.0 | 82.81 |
| | F15 | 7.78 | 9.6 | 133.2 | 87.08 |
| | Average | 8.49 ± | 9.8 ± | 99.5 ± | 80.62 ± |
| | | 0.39 | 0.15 | 25.64 | 23.93 |

1 lbm/gal = 119.8 kg/m³

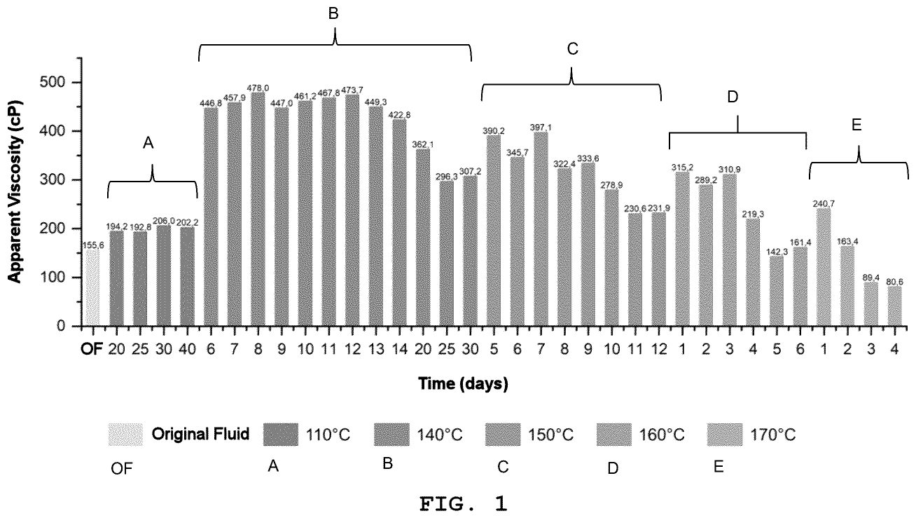

Analyzing the average values calculated for each condition, and presented in Tables 3, 4, 5, 6, 7, and 8, it is possible to observe significant increases in apparent viscosity after the fluids were exposed to the temperature. As can be seen in the graph presented in FIG. 1, the average apparent viscosity was higher than that obtained with the original fluid in all temperature conditions of 110° C., 140° C., and 150° C. and up to the third day of exposure to the temperature of 160° C. and the second day at 170° C.

It is further possible to observe a tendency for this property to increase with an increasing temperature, when comparing the results obtained between the original fluid and after exposure to 110° C. and also to 140° C. However, from 140° C. onwards, the apparent viscosity gradually decreased until the temperature of 170° C. In addition, the viscosity also decreased with the increasing exposure time, an effect especially evident in the samples exposed to 170° C. for 1, 2, 3, and 4 days.

This behavior of the viscosity can be explained by the interactions between the bentonite particles that occur under the influence of the temperature. With the exposure of the fluid to the temperature, there is an increasing tendency for the formation of edge-edge or face-edge associations between the clay particles, which leads to the formation of a “house of cards” type structure. The system is then said to be flocculated, and the consequence of this is an increase in the viscosity of the fluid. However, in a system containing electrolytes, such as the studied fluid, a gradual increase in temperature or exposure time can lead to a change from a flocculated state to an aggregation state of the clay particles, through an increase in face-face associations caused by the collapse of the diffuse double layer, leading to a reduction in the viscosity of the system (ANNIS, M. R. High-Temperature Flow Properties of Water-Base Drilling Fluids. Journal of Petroleum Technology, v. 19, n. 08, p. 1074-1080 August 1^{st}, 1967; CAENN, R.; DARLEY, H. C. H.; GRAY, G. R. Composition and Properties of Drilling and Completion Fluids. 6th ed. [s.1.] Gulf Professional Publishing, 2011; VRYZAS, Z.; YIMING, W.; GEROGIORGIS, D. I.; KELESSIDIS, V. C. Understanding The Temperature Effect on the Rheology of Water-Bentonite Suspensions. In: Nordic Polymer Days (NPD) and Nordic Rheology Conference (NRC), 2016, Helsinki. Annual Transactions of the Nordic Rheology Society. Helsinki, 2016. p. 199-208).

With respect to the fluids exposed to the higher temperatures, it is possible to observe visibly lower apparent viscosity values, and from the fifth day of exposure at 160° C. and from the third day at 170° C. this property is considerably reduced, and to values below that obtained with the original fluid, characterizing the fluid failure. This behavior, in addition to indicating the phenomenon of aggregation of the clay particles in a more pronounced way, may also be related to the degradation of the fluid components under these conditions, mainly the polymers.

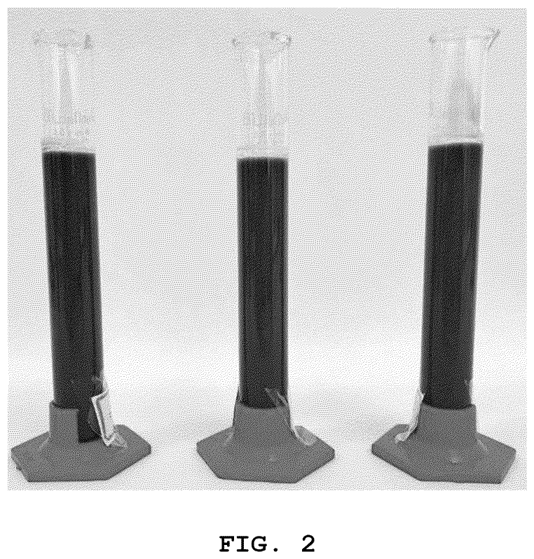

In addition, it is important to highlight that, up to a temperature of 150° C., only 2.32% of the samples tested (6 out of a total of 259) showed an apparent viscosity lower than that of the original fluid, and were considered failures according to this criterion. However, from 160° C. onwards, the number of failures increased considerably. Of the 140 samples tested at both temperatures (160° C. and 170° C.), 53 did not meet the criterion, which corresponds to 37.9% of the total. Despite this, the fluid remained efficient with regard to maintaining the particles in suspension, as can be seen in FIG. 2, which represents a sample after being exposed for 4 days at 170° C. and then remaining at rest for 7 days at room temperature (22° C.).

This result is important because it ensures that the hydrostatic pressure supplied by the fluid is able to remain homogeneous along the column, without phase separation (sedimentation) occurring, even under more severe conditions. This behavior is ideal for application in the temporary abandonment of wells.

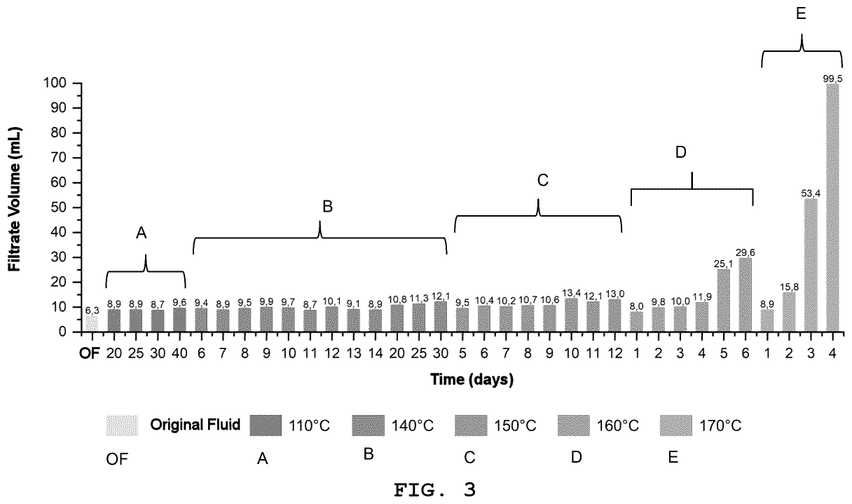

Further, according to the data presented in Tables 4, 5, 6, 7, and 8, it is possible to realize that the average values obtained for the filtrate volume under conditions of 110° C., 140° C. (up to 14 days), 150° C. (up to 9 days), 160° C. (up to 3 days), and 170° C. (1 day) remain very close, regardless of the temperature and the inspection time. Although an increase in the average value is observed with an increasing exposure time, this is not considered significant, since the increases are very small, less than 2 mL. This behavior can be better observed in the graph presented in FIG. 3.

However, after 20 days of exposure at 140° C., 10 days at 150° C., 4 days at 160° C., and 2 days at 170° C., it is noticeable that the averages calculated for these conditions already characterize the failure by filtrate volume, with values greater than or equal to 10.8 mL. For the conditions of 160° C. and 170° C., it is further possible to observe a much more significant variation in the filtrate volume with the increasing exposure time. From the fifth day of exposure at 160° C. and the third day at 170° C., quite high and excessive filtrate volumes are observed, consistent with the behavior in the control, in which a large volume is filtered in the first seconds of the test. These results were accompanied by a quite significant reduction in apparent viscosity when compared with the values obtained for the original fluid. This behavior may be associated with a more pronounced degradation of the fluid components, as discussed earlier, especially the LV PAC and HV PAC polymers, which act as a filtrate control agent and a viscosifying agent, respectively.

According to the literature (PLANK, J. P.; GOSSEN, F. A. Visualization of fluid-loss polymers in drilling-mud filter cakes. SPE Drilling Engineering, v. 6, n. 03, p. 203-208, 1991), the complete degradation of PAC occurs at a temperature of 300° F. (approximately 150° C.) in fluids supplemented with NaCl. For this type of polymer, the most likely thermal degradation mechanism is the hydrolysis of the acetal groups of the main chain of the polysaccharide (RYLES, R. G. Elevated Temperature Testing of Mobility Control Reagents. In: SPE Annual Technical Conference and Exhibition, 1983, San Francisco. Proceedings [ . . . ]. [S. L.]: SPE, 1983. p. 1-10). The hydrolysis consists of a chemical reaction in which a water molecule is used to break chemical bonds in another molecule. In the case of the polymers, this process typically leads to the breakdown of polymer chains into smaller units, reducing their molecular weight (CZEISZPERGER, R. Polyurethane Elastomer Hydrolytic Stability: A Comprehensive Review. In: Polyurethane Manufacturer's Conference, 2012, New Orleans. Proceedings [ . . . ], 2012. p. 1-15).

With respect to the formulation of the green e-BIS fluid and its exposure to temperature, the degradation of the LV and HV PACs results in an increase in the filtrate volume and a reduction in viscosity, since the absence of the protective barrier that this polymer forms on the bentonite surface causes the clay to dehydrate and, consequently, lose its “house of cards” structure by forming face-face interactions (PLANK, J. P.; GOSSEN, F. A. Visualization of fluid-loss polymers in drilling-mud filter cakes. SPE Drilling Engineering, v. 6, n. 03, p. 203-208, 1991). With the increased exposure time to this temperature, the polymer degradation would then be even more severe. However, as mentioned earlier, the filtrate volume values of the fluids exposed to the polymer degradation temperature (150° C.) remain very similar (with differences close to 1 mL) for up to 9 days of exposure.

This behavior therefore points to a delay in the degradation of LV and HV PACs, even when subjected to 150° C. for a long period of time, which can be explained by the presence of glycerin in the fluid by means of two hypotheses: i) the first hypothesis considers the formation of a barrier around the LV and HV PACs due to the intermolecular interactions, specifically through hydrogen bonds between the hydroxyl groups of the glycerin molecules. This barrier would be acting to prevent the free water from the system from coming into contact with the polymers, thus preventing the degradation process by hydrolysis; ii) the second hypothesis considers that, in addition to the intermolecular interactions formed through hydrogen bonds between the hydroxyl groups of the glycerin molecules, interactions of the same class also occur between the glycerin molecules and the hydroxyl groups of the free water molecules, and with the hydroxyl groups present in the polymers. These interactions form a dense system of molecules, similar to a three-dimensional network, which prevents the mobility of water and, consequently, the hydrolysis of the polymers.

In this way, according to the two hypotheses proposed, the complete degradation of the PACs would only occur after the degradation of glycerin, allowing the polymer chain to be exposed to contact with the water molecules. According to the literature (ALMAZROUEI, M.; SAMAD, T. E.; JANAJREH, I. Thermogravimetric Kinetics and High Fidelity Analysis of Crude Glycerol. Energy Procedia, [S. L.], v. 142, p. 1699-175 Dec. 2017; ALMAZROUEI, M.; ADEYEMI, I.; JANAJREH, I. Thermogravimetric assessment of the thermal degradation during combustion of crude and pure glycerol. Biomass Conversion and Biorefinery, [S. L.], v. 10, p. of crude glycerol and glycerol pitch from palm-based residual biomass. Biomass Conversion and Biorefinery, [S. L.], v. 12, n. 10, p. 4403-4417 Mar. 18, 2022; and ARMYLISAS, A. H. N.; HOONG, S. S.; ISMAIL, T. N. M. T. Characterization of crude glycerol and glycerol pitch from palm-based residual biomass. Biomass Conversion and Biorefinery, [S. L.], v. 1, n. 1, p. 1-13, 2 Mar. 2023), crude glycerin, or blond glycerin, has its degradation process initiated at temperatures close to 150° C., but the mass loss observed in this range is very small. The complete degradation of this product only occurs at much higher temperatures, around 250° C. Thus, the results obtained are in accordance with the hypotheses, since it was necessary to expose the green e-BIS fluid for prolonged periods, or to temperatures considered excessive, to observe the fluid failure.

For the degradation temperature of polymers in saline solution (150° C.), for example, 6 days of exposure were necessary for the first samples to fail (5 samples out of a total of 15), and 10 days of exposure for total failure, which occurs when all samples tested under that condition fail. When the temperature increases, however, the required exposure time decreases considerably. For temperatures of 160° C. and 170° C., the first failures occurred after 2 days of exposure, but only 3 samples failed at 160° C., while at 170° C., 11 failed. Total failure for these temperatures occurred in 5 days and 3 days, respectively.

In general, it was observed that the predominant failure mode to which the green e-BIS fluid is subject is the filtrate control, since all samples that failed by the apparent viscosity criterion also failed by the filtrate volume. In addition, the number of total failures by this criterion was considerably higher. Of the 399 samples tested with the sampling plan, 177 failed by the filtrate volume, of which 59 samples also failed by the apparent viscosity. In addition, as mentioned earlier, the reduction in the viscosity did not compromise the fluid's ability to keep the particles in suspension. This ensures the density homogeneity along the fluid column and, consequently, the maintenance of the hydrostatic pressure. The loss of the liquid phase, however, represented by the increase in the filtrate volume, raises the fluid density, since the solids would remain dispersed in a smaller volume. This behavior can alter the hydrostatic configuration of the well, compromising the temporary abandonment operation.

However, it is possible to state that the developed green e-BIS fluid exhibits an excellent filtrate control, as it manages to maintain this property below the failure criterion for extended periods at lower temperatures (110° C. and 140° C.) and at the polymer decomposition temperature (150° C.), in addition to remaining stable at high temperatures (160° C. and 170° C.) for short periods of time.

### CONCLUSION

Through testing, it was possible to observe the failure of the green e-BIS fluid at temperatures of 140° C., 150° C., 160° C., and 170° C.; however, at 110° C., the fluid failure had not yet occurred, with a maximum exposure time of 40 days. The fluid failure under the aforementioned conditions occurred predominantly due to an increase in the filtrate volume to values above the failure criterion. The failure due to a reduction in the apparent viscosity occurred simultaneously with the failure due to filtrate volume, and the lower the fluid viscosity in these cases, the greater the volume of filtrate collected.

Those skilled in the art will appreciate the knowledge presented herein and may reproduce the invention in the presented embodiments and in other variants, encompassed within the scope of the attached claims.

What is claimed is:

1. A formulation for abandoning oil wells, comprising:
(a) a first cellulosic agent;
(b) a second cellulosic agent;
(c) bentonite clay;
(d) glycerin; and
(e) water,
wherein (i) the first cellulosic agent is a low viscosity polyanionic cellulose or a low viscosity carboxymethylcellulose, and (ii) the second cellulosic agent is a high viscosity polyanionic cellulose or a high viscosity carboxymethylcellulose.

2. The formulation according to claim 1, wherein components of the formulation are present in the following concentrations:
(a) 1 to 10 lbm/bbl (2.853 to 28.53 kg/m³) of the first cellulosic agent, preferably 4 lbm/bbl (11.412 kg/m³),
(b) 0.1 to 1 lbm/bbl (0.285 to 2.853 kg/m³) of the second cellulosic agent, preferably 0.25 lbm/bbl (0.713 kg/m³),
(c) 5 to 30 lbm/bbl (14.265 to 85.59 kg/m³) of bentonite clay, preferably 10 lbm/bbl (28.53 kg/m³), and
(d) 20 to 300 lbm/bbl (57.06 to 855.903 kg/m³) of glycerin, preferably 200 lbm/bbl (570.602 kg/m³), and
wherein water is a diluent of said formulation.

3. The formulation according to claim 1, further comprising additional components of:
(e) sodium bicarbonate;
(f) an antifoaming agent;
(g) sodium hydroxide;
(h) magnesium oxide;
(i) sodium chloride; and
(j) a bactericide.

4. The formulation according to claim 3, wherein the additional components are present in the following concentrations:
(e) 0.1 to 1 lbm/bbl (0.285 to 2.853 kg/m³) of sodium bicarbonate, preferably 0.5 lbm/bbl (1.427 kg/m³),
(f) 0.1 to 1 lbm/bbl (0.285 to 2.853 kg/m³) of antifoaming agent, preferably 0.3 lbm/bbl (0.856 kg/m³),
(g) 0.1 to 1 lbm/bbl (0.285 to 2.853 kg/m³) of sodium hydroxide, preferably 0.2 lbm/bbl (0.571 kg/m³), (h) 1 to 5 lbm/bbl (2.853 to 14.265 kg/m³) of magnesium oxide, preferably 3 lbm/bbl (8.559 kg/m³),
(i) 4.41 to 126 lbm/bbl (12.582 to 359.479 kg/m³) of sodium chloride, preferably 108 lbm/bbl (308.125 kg/m³), and
(j) 0.1 to 1 lbm/bbl (0.285 to 2.853 kg/m³) of bactericide, preferably 0.3 lbm/bbl (0.856 kg/m³).

5. The formulation according to claim 3, wherein the antifoaming agent is selected from the group comprising a nonionic surfactant, silicone compounds, high molecular weight alcohol or compositions prepared with mixtures of these components.

6. The formulation according to claim 3, wherein the antifoaming agent is a nonionic surfactant.

7. The formulation according to claim 6, wherein the nonionic surfactant is 2, 2, 4-trimethylpentane 1, 3-diol monoisobutyrate.

8. The formulation according to claim 3, wherein the bactericide is selected from the group comprising saturated dialdehydes or triazines.

9. The formulation according to claim 3, wherein the bactericide is saturated dialdehydes.

10. The formulation according to claim 9, wherein the saturated dialdehydes are glutaraldehyde.

11. A process for producing the formulation for abandoning oil wells according to claim 1, the process comprising the following steps:
(a) addition of bentonite clay to water, and agitation; obtaining a first viscous bed;
(b) addition of the antifoaming agent, sodium bicarbonate, first cellulosic agent and second cellulosic agent in a sodium chloride solution, and agitation; obtaining a second viscous bed;
(c) keeping the first and second viscous beds at rest; and
(d) mixing the first viscous bed into the second viscous bed, followed by the addition of water, sodium hydroxide, magnesium oxide, glycerin and bactericide, and agitation; and obtaining the formulation for abandoning oil wells.

12. The process according to claim 11 wherein the steps are performed under the following conditions:
in step (a), the agitation is carried out for a time of 10 to 30 minutes, preferably 20 minutes, at a temperature of 20 to 25° C., preferably 22° C., with the agitation rate being 1000 to 5000 rpm, preferably 3000 rpm;
in step (b), the agitation is carried out for a time of 10 to 30 minutes, preferably 20 minutes, at a temperature of 20 to 25° C., preferably 22° C., with the agitation rate being 1000 to 5000 rpm, preferably 3000 rpm; and
in step (d), the agitation is carried out for a time of 10 to 30 minutes, preferably 20 minutes, at a temperature of 20 to 25° C., preferably 22° C., with the agitation rate being 1000 to 5000 rpm, preferably 3000 rpm.

13. The process according to claim 11, wherein, in step (a), the viscous bed comprises bentonite clay at a concentration of 35 lbm/bbl (99.86 kg/m³), and, in step (b), the sodium chloride solution is an aqueous solution at the concentration as defined in the formulation for abandoning oil wells.

14. The process according to claim 11, wherein, in step (c), the first and second viscous beds are kept at rest for a period of 1 to 40 hours, preferably 10 to 30 hours, more preferably 16 hours, wherein said rest is carried out at a temperature of 22° C.
